(19) United States
(12) Patent Application Publication
(10) Pub. No.: US 2025/0391156 A1
(43) Pub. Date: Dec. 25, 2025

(54) SELF-SUPERVISED MULTI-REPRESENTATION LEARNING FOR RADAR-CAMERA DATA

(71) Applicant: RADAREYE LTD, London (GB)

(72) Inventor: Mohammed Alloulah, Letchworth Garden City (GB)

(73) Assignee: RADAREYE LTD, London (GB)

(21) Appl. No.: 19/243,105

(22) Filed: Jun. 19, 2025

Related U.S. Application Data
(60) Provisional application No. 63/661,642, filed on Jun. 19, 2024.

(51) Int. Cl. G06V 10/774; G01S 13/86; G06V 10/74; G06V 10/82; G06V 20/40

(52) U.S. Cl. CPC G06V 10/774; G01S 13/867; G06V 10/761; G06V 10/82; G06V 20/40

(57) ABSTRACT

A perception system implemented as a base neural network is trained on training data elements describing the evolution of an environment during a period of time, and having multimodal data formats: (1) a consecutive sequence of RGB images, (2) a consecutive sequence of radar range-azimuth heatmaps, and (3) a set of Doppler spectrograms. The base neural network may later be used in a specific perception application after training. For example, the pretrained neural network model or a subset of its layers may be used in another neural net (a “task-specific network”) which is trained to perform a task on at least a received radar data set captured from a real-world environment.

### CROSS REFERENCE TO RELATED APPLICATION

The present application claims the benefit of U.S. Provisional Patent Application No. 63/661,642 filed Jun. 19, 2024, which is incorporated herein in its entirety.

### FIELD

The disclosure relates to a method for training a base neural network for processing radar data captured from a scene.

### BACKGROUND

Radar is an important enabler of robust perception for a number of vision applications, such as advanced driver-assistance systems (ADAS) or full self-driving. Radar uses radio frequency (RF) signals (i.e. the range 3 kHz and 300 GHz) that, unlike electromagnetic (EM) signals in other frequency domains, are uniquely able to propagate through bad weather conditions such as snow and fog, or dust particles from pollution such as smog. As such, radar is a sensing modality that may support robust perception under challenging visibility conditions when other visual modalities such as camera and lidar (light detection and ranging) fail.

Multimodal machine learning is used to fuse radar data with other visual modalities such as camera images. For example, the fusion of camera and radar data allows a system to continue to perceive the environment under bad visibility conditions such as snowstorms or smog. This is because a fusion perception system would be able to adjust its operation to rely on radar signals more when optical perception degrades.

Radar can also support privacy-preserving perception. This is because radar signals, which have a wavelength of at least a few millimeters, perceive an environment which may include people without capturing their private information such as their facial features and exact bodily shapes. Camera-radar fusion for privacy-preserving perception could disable information from the input camera stream altogether when humans are in the field of view, and only rely on radar information. Under such settings, camera-radar fusion is needed only during the training phase, while relying on standalone radar signals during the inference stage. Applications for such technology are wide-ranging, for example elder care, building analytics, and security monitoring.

### SUMMARY

In accordance with some example embodiments, it is proposed that a perception system implemented as a neural network is obtained using a base neural network trained on training data elements describing the evolution of an environment during a period of time (e.g. a period of a few milliseconds to a few seconds). Each training data element includes corresponding multimodal data formats: (1) a visual data set of visible frequency image data (e.g. a consecutive sequence of RGB images), (2) a radar data set which is a consecutive sequence of radio frequency (i.e. radar) data sets (e.g. range-azimuth heatmaps), and (3) a Doppler data set (e.g. a set of Doppler spectrograms). For a given data element, the visual data set, radar data set and Doppler data set correspond to each other in the sense that they each depict, with different corresponding modalities, a scene for the data element. The scene includes one mor more objects in a real-world environment.

The use of visible frequency data means that it is possible to make use of vast quantities of data for automatic feature learning. The term visible frequency is used here to mean frequencies above the upper frequency range of radio waves (e.g. higher than 300 GHz), and preferably EM radiation in the visible frequency band (490 to 790 THz). In accordance with some example embodiments, the visible frequency image data is an RGB sequence, such as a video snippet, i.e. a sequence of still RGB images captured by a video camera.

In accordance with some example embodiments, the radar data sets are multidimensional data set, such as a range-azimuth sequence of heatmaps or a range-azimuth-elevation sequence of point clouds. The radar data sets correspond partially or exactly to the duration of the scene from the RGB sequence, but as perceived by radar instead of a video camera.

Employing Doppler data, such as Doppler data obtained from the radar data, is also desirable to incorporate radar's unique sensing properties (e.g., accurate velocity estimation) into the fusion model. Doing so makes it possible to implement more sophisticated sensing applications (“tasks”) using a base neural network trained using fused camera and radar features. For example, a camera-radar fusion system such as the one disclosed in this patent may not only be able to track the movements of objects (e.g., cars and pedestrians), but also simultaneously estimate their instantaneous velocities, which allows for building richer applications.

In accordance with some example embodiments, the set of Doppler spectrograms are constructed from the radar slow-time spectra from the multidimensional radar data sliced at a set of moving objects present in the dynamic scene, such as cars and pedestrians.

In accordance with some example embodiments, the base neural network is trained by iteratively updating numerical parameters (e.g. at least a 100 million, or a billion numerical parameters) which define portions of the base neural network based on maximizing a reward function (or equivalently minimizing a loss function). Each iteration uses a batch of one or more training data elements (training examples) The reward function may be based on one or more similarity scores for each training data element. Thus, each iteration of the training may include, for each training data element in a batch of the training data elements in the training database, (a) computing a similarity score between an output based on the RGB sequence and an output based on the range-azimuth sequence, and (b) computing a similarity score between the output based on the RGB sequence and an output based on at least one Doppler spectrogram.

In accordance with some example embodiments, the base neural network may be used in a specific perception application after training. For example, the pretrained neural network model or a sliced subset of its layers may be used in another (e.g. larger) neural network (a “task-specific network”) which is trained to perform a perception task (“task”) on at least a received radar data set captured from a real-world environment including a scene, in order to perform a perception task of generating at least one label to label the radar data. Optionally, the test neural network may also receive at least a corresponding visual data set of the same scene.

For example, the perception task may be to identify one or more objects (a term which is used here to include persons) in the scene, and to generate a respective label for each object including data which is indicative of the position of the object in the scene (e.g. two-or three-dimension data specifying a position in the scene), and/or descriptive of the object and/or descriptive of a motion of the object. For example, the label may indicate that the object is a member of one of a plurality of classes (e.g. “cars”, “trees”, “persons”), and/or may indicate a size of the object, and/or a speed and/or direction of travel of the object within the real-world environment.

### BRIEF DESCRIPTION OF DRAWINGS

For a proper understanding of example embodiments, reference should be made to the accompanying drawings, wherein:

FIG. 1 illustrates a base neural network configured to receive corresponding date in multiple data formats.

FIG. 2 illustrates training the base neural network of FIG. 1.

FIG. 3 illustrates an example of how the training of the neural network is optimised

for computational resources such as memory as well as for learning performance.

FIG. 4, which is composed of FIG. 4A and FIG. 4B, shows two forms of a task-specific network comprising part of the trained base neural network.

FIG. 5 illustrates a method to form and use a task-specific neural network using a base neural network which is trained (or pre-trained) separately on unlabeled paired camera-radar data.

FIG. 6 shows the structure of a computer system which can perform the method of FIG. 5.

### DETAILED DESCRIPTION

It would be desirable if perception based on radio waves could be implemented with minimal human intervention, such as by using training data to train machine learning systems such as neural networks, so that human insight is less essential. However, whereas a very large amount of labelled training conventional image data exists for training visual machine learning systems to perform imaging tasks, much less is available for training systems which perform perception based on captured radio-wave data. This factor limits development of the technology.

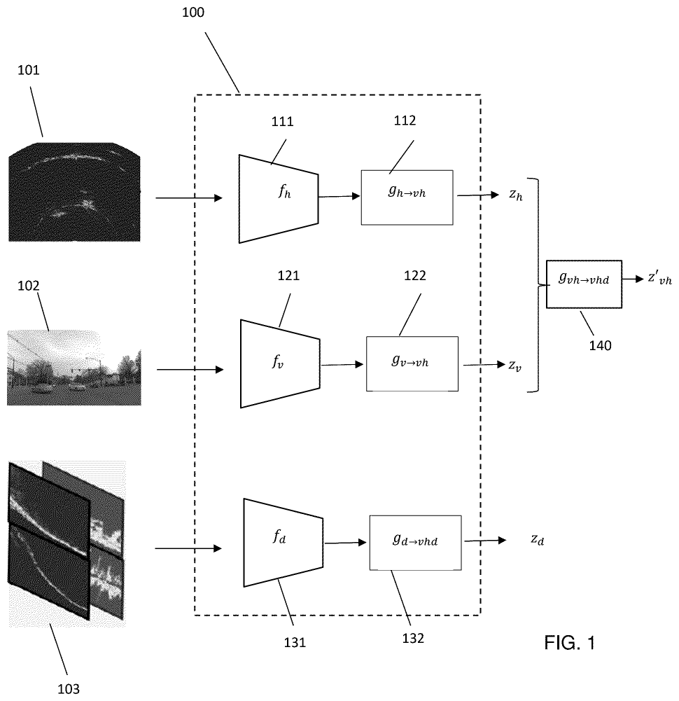

FIG. 1 illustrates an embodiment of the system in which a base neural network 100 receives at any time corresponding data in multiple data formats. Specifically, the data formats may be: (1) a radar data set 101 in the form of a consecutive sequence of range-azimuth heatmaps, (2) a visual data set 102 in the form of a consecutive sequence of RGB images, and (3) a set 103 of Doppler spectrograms.

The base neural network 100 comprises three subnetworks (“branches”). Each of these may be implemented using known processing layers, defined by respective sets of variable neural network parameters.

A first processing branch 111 (“radar network”) is configured to process, and specifically to encode, a radar data set in the form of a consecutive sequence of radar heatmaps 101. Each radar heatmap is encoded by encoder ƒₕ as a respective encoded radar data set. Thus, a space-time encoding is created.

A second processing branch 121 (“visual network”) is configured to process, and specifically to encode, a visual dataset in the form of a consecutive sequence of RGB images 102. Each image is encoded by encoder ƒᵥ as a respective encoded visual data set. Thus, a space-time encoding is created.

A third processing branch 131 (“Doppler network”) is configured to process, and specifically to encode, Doppler data in the form of a plurality of Doppler spectra (spectrograms), representing the motions of respective objects in the environment (e.g. a car or a pedestrian, or a non-moving object such as a tree or item of road furniture) at respective times (“moments”) within a time period. The Doppler encoder ƒ_{d} encodes each spectrum as a respective encoded Doppler spectrum. The spectra are not pooled across objects. In principle, the spectra for a given object could be “summarized” across the times in one time period using pre-processing, before being input to the encoder ƒ_{d}. However, it is computationally simpler not to do this, and for the Doppler data input (sequentially) to the encoder ƒ_{d} to be a corresponding sequence of spectrograms for each object at respective times within the time period, such that the encoder ƒ_{d} generates a respective encoded spectrogram for each object and each of the times (moments) in the time period.

The space-time encodings are pooled in space and time (optionally, e.g., via average pooling), and then projected into a common one-dimensional space, by respective projection heads (projection units) 112, 122, which perform projections, respectively denoted g_{h→vh} and g_{v→vh}, to form respective projections denoted zₕ and zᵥ.

The encoded Doppler spectra are each also projected into a one-dimensional space, by a projection head 132, which perform a projection denoted g_{d→vhd}. The functions g_{h→vh}, g_{h→vh} and g_{d→vhd} (and g_{vh→vhd} given below) are defined by (large) weight matrices of tunable numerical parameters and (pre-defined) non-linearities,

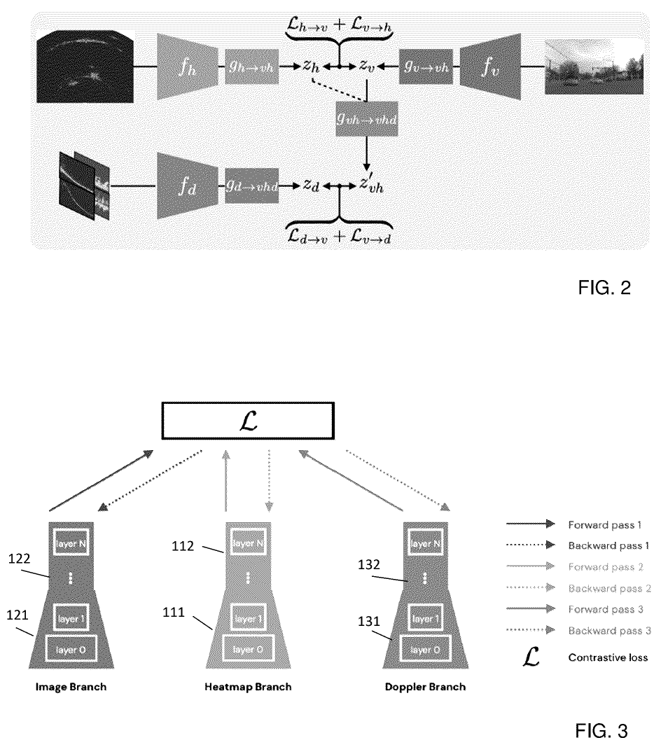

Referring to FIG. 2, a process of training the base neural network 100 is illustrated using contrastive losses. The training is performed using a training database comprising a plurality of (training) data elements. Each data element comprises a corresponding radar data set 101, a corresponding Doppler data set 103 and a corresponding visual data set 102. These each describe the evolution of a corresponding scene during a time period (e.g. a fraction of a second or a few seconds). For example, the radar dataset may be a sequence of heatmaps for respective times (moments) during the time period, and the visual data set may be a sequence of images captured at respective times (moments) during the time period. The Doppler data 103, as described below, may be in the form of Doppler spectra, representing the motions of respective objects in the environment during the time period.

The Doppler spectra 103 may be derived from the radar data set for the training element, e.g. offline before any training of the base neural network is carried out (or while the iterative training procedure is carried out, e.g. to avoid having to store the Doppler data in the training database). There are a number of ways to do so. One option is to exhaustively search each space-time scene (a) in each ranging interval to determine potential target peaks, and (b) at and around range peaks across the Doppler dimension to slice spectra with significant Doppler energies. These energies are then associated using range peak information, aggregated in time, and ranked. Top K samples are then retained and designated as the Doppler positives. Another option is to use target tracking and association logic on heatmaps to hone in on regions of interest in space and across time in order to speed up the exhaustive search. Yet another faster option is to designate a crude region around activities of interest in heatmaps (again in space and across time) and simply sum their Doppler energies and aggregate across time to use as positives.

A training iteration using one of the training data elements will now be defined. For simplicity it is assumed that one training data element is used. Note that the iteration may alternatively be implemented using multiple training data elements at each iteration, i.e. a batch implementation.

The projection heads used for the visual data set and radar data set are intended to convert the encoding from a modality encoding to a shared representation designed to account for the nuances of a radar-camera learning system as follows.

First, since RGB images and radar heatmaps both measure the environment spatially, they are projected to a shared space (denoted as vh) using projector heads g_{h→hv} and g_{v→hv} that give respectively projection vectors zₕ and zᵥ. Using the projections zₕ and zᵥ, a first bidirectional (i.e. symmetric as between v and h) contrastive loss [symbol] _{h→v}+ [symbol] _{v→h} is computed. For each one-sided loss, one of many contrastive loss variants may be used such as Aaron van den Oord, Yazhe Li, and Oriol Vinyals. Representation learning with contrastive predictive coding. arXiv preprint arXiv:1807.03748, 2018. Concretely, an example one-sided loss based on the information noise contrastive estimation (InfoNCE) variant is given as

$${ℒ}_{v \to h} = - {\sum }_{i}^{B} log ( \frac{exp ( {𝓏}_{v , vh}^{i ⊤} {𝓏}_{h , vh}^{i} / τ )}{exp ( {𝓏}_{v , vh}^{i ⊤} {𝓏}_{h , vh}^{i} / τ ) + {\sum }_{j \neq i} exp ( {𝓏}_{v , vh}^{{i}^{⊤}} {𝓏}_{h , vh}^{i} / τ )} )$$

where B is the batch size (i.e. a number of training data elements used in the iteration), i is an integer index which labels the training data elements of the batch, τ is a softmax temperature hyperparameter, and z_{(·),vh} denotes explicitly a vision-heatmap shared projection space. That is, z_{v,vh} and z_{h,vh} have the same meanings as zᵥ and zₕ given above.

Radar Doppler spectra 103, on the other hand, analyse the rate of change of targets across time and do not immediately map onto the same vh space. As such, projecting them onto the same (spatial) shared representation used for RGB images and radar heatmaps is undesirable. Instead, zᵥ (or in a variation zₕ) is projected using a projection head 140 to generate a one-dimensional projection vector g_{vh→vhd}, to generate a representation z′ᵥₕ. Note that the notation vh is used here to mean that either v or h may be used. The corresponding Doppler encodings of the training data element are projected using the projection head 132g_{d→vhd}, in order to obtain the projection Z_{d}. Here the three-way shared representation is denoted by vhd. These shared representations are then compared using a second bidirectional contrastive loss [symbol] _{d→v}+ [symbol] _{v→d}. An example one-sided InfoNCE loss is given as

$${ℒ}_{v \to d} = - {\sum }_{i}^{B} log ( \frac{exp ( {𝓏}_{vh , vhd}^{′ i ⊤} {𝓏}_{h , vhd}^{i} / τ )}{exp ( {𝓏}_{vh , vhd}^{′ i ⊤} {𝓏}_{h , vhd}^{i} / τ ) + {\sum }_{j \neq i} exp ( {𝓏}_{vh , vhd}^{′ {i}^{⊤}} {𝓏}_{h , vhd}^{i} / τ )} )$$

where z_{(·),vhd} denotes explicitly the three-way (vision-heatmap-Doppler) shared projection space, and B and τ are as before. That is, z_{vh,vhd} and z_{d,vhd} have the same meanings as zᵥₕ and z_{d} given above.

Note that because the radar Doppler spectra 103 of the training data element are analytically (and linearly) estimated from the set of radar heatmaps 103 at respective moments in the time period, learning is preferably not applied between these two representations. This is similar at a high-level to not training multimodal image-sound-text systems on loss terms between sound and text when text has actually been derived from sound using another captioning system (Alayrac J B, Recasens A, Schneider R, Arandjelović R, Ramapuram J, De Fauw J, Smaira L, Dieleman S, Zisserman A. Self-supervised multimodal versatile networks. Advances in Neural Information Processing Systems. 2020).

During the training, the respective sets of numerical parameters defining the encoders ƒₕ, ƒᵥ and ƒ_{d}, and the projection heads g_{h→vh}, g_{v→vh}, g_{d→vhd} and g_{vh→vhd} are iteratively updated. The iterative process finishes with a (first) termination criterion is met, for example that the number of iterations has reached a threshold, or that a certain number of computing operations has been performed.

The learning configuration depicted in FIG. 2 retains the network architectural flexibility needed to account for the different nature, information density, and granularity of RGB images, radar heatmaps, and radar Doppler spectra. Further, it allows us to “retrieve” (estimate) the corresponding Doppler content (i.e., movements) of a scene either using RGB images (using the units 121, 122 and 140) or radar heatmaps (using the units 111, 122 and 140) which can be implemented using a very efficient vector-matrix dot product (or matrix-matrix when batched). This retrieval-based Doppler estimation represents an ultra-fast parallel parameter estimation method that bypasses traditional sequential radar processing.

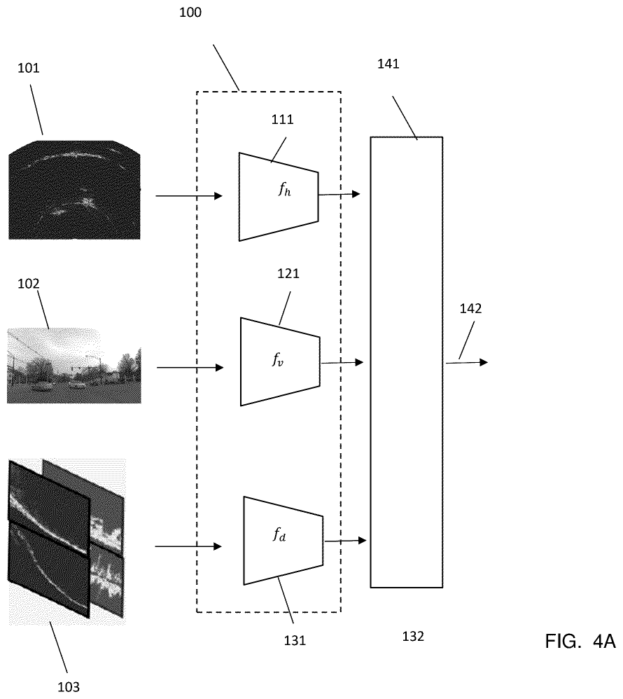

In order to train the network, an alternating procedure is used that allows us to increase the capacity of the three branch architecture while minimising the associated GPU memory footprint and enhancing the stability of contrastive learning. Specifically, as shown in FIG. 3, in a given one of the training iterations one or more of (e.g. each of) the three branches 111, 121, 131 may be updated. This may be performed in turn. That is, a given one of the branches performs a full round of updates comprising a forward pass (i.e. generating an encoding of the respective data set) and a backward pass (e.g. a back-propagation step), before the method proceeds to update next branch sequentially (e.g., in a round-robin fashion). This reduces significantly the peak GPU memory utilisation, and has in fact better stochastic optimisation properties (Akbari, Hassan, et al. Alternating gradient descent and mixture-of-experts for integrated multimodal perception. Advances in Neural Information Processing Systems, 2024).

For both the RGB image encoder 121 (“visual network”) and the radar heatmap encoder 111, backbones that support spatiotemporal modelling are used, such as 3D convolutional nets (and their optimised 2D-based variants; see J. Johnson, M. Douze, and H. Jégou. Billion-scale similarity search with GPUs. IEEE Transactions on Big Data, 2019, and S. Xie, C. Sun, J. Huang, Z. Tu, and K. Murphy. Rethinking spatiotemporal feature learning: Speed-accuracy trade-offs in video classification. In ECCV, 2018) or transformers with position embeddings. For conv nets, spatial and temporal average pooling are applied at the top of the branch in order to reduce the dimensionality to a 1D feature vector. For transformers, learnt query vectors allow decoding the spatiotemporal representations into 1D feature vectors. For the radar Doppler encoder, a 2D conv net is used similar to variants used for automatic speech recognition (ASR) systems.

For the radar Doppler encoding, a number of spectra are used as positive examples. This is because a scene could have multiple independently moving objects of interest that have significant Doppler content, such as a car and a pedestrian. These objects may be further separated in range and angle within the radar data structure. A modified contrastive loss such as MIL-NCE (see A. Miech, J.-B. Alayrac, L. Smaira, I. Laptev, J. Sivic, and A. Zisserman. End-to-End Learning of Visual Representations from Uncurated Instructional Videos. In CVPR, 2020) can be used which is computed from multiple positive samples as opposed to only one positive as prevalent in other vision systems.

Once the three-branch network has been trained, a sequence of either RGB images or radar heatmaps can be used to query for the scene's Doppler profile. Specifically, the joint embedding vectors zᵥ or zₕ can be projected using g_{vh→vhd} in order to produce a representation z′ᵥₕ that can be readily compared (using a dot product) against a representative set of prototype z_{d} vectors that encapsulate all physically plausible Doppler scenarios. The response of this vector-matrix dot product is then maximised (i.e., argmax'ed) to arrive at the Doppler content that most closely correlates with the query sequence of RGB images or heatmaps. Multiple such prototype vectors corresponding to multiple independently moving targets can be selected.

Regardless of how much processing is incurred for Doppler positive sampling during the dataset construction phase, once the network is trained, inferring the Doppler content associated with an RGB video (or a snippet of radar heatmaps) will be performed ultra-fast using the retrieval methodology outlined above. This is because the network would have effectively “neurally assimilated” the knowledge needed (using gradient descent) in order to perform such Doppler retrieval very efficiently.

The vision branch 121 may also incorporate data augmentation strategies in order to enhance learning, along with its associated loss modifications. Similarly, newly proposed augmentations for multiple-input multiple-output (MIMO) radar may be incorporated for the heatmap branch (Y Hao, S Madani, J Guan, M Alloulah, S Gupta, H. Hassanieh. Bootstrapping Autonomous Driving Radars with Self-Supervised Learning, In CVPR, 2024).

In another embodiment, a 3D point cloud may be used instead of the 2D heatmap and inputted as data at the range-angle branch. In such a case, angular information supplied by radar would include both azimuth and elevation. In order to support this higher input dimensionality and at higher computational complexity, a transformer backbone may be used in order to embed the 4D (range, azimuth, elevation, and time) higher dimensional tensor into a 1D vector space for contrastive learning.

Another embodiment may use two different but also complementary radar data representations. Earlier one embodiment was detailed that uses range-angle heatmaps and Doppler spectrograms, which together cover all the information radar is able to measure natively at the physical signaling level through radar modulation, demodulation, and signal processing. Another representative set may be range-Doppler heatmaps and angle spectra, which together too cover the same radar primitives, albeit slightly permuted. Similar principles apply for learning radar-camera embeddings and for fast retrieval-based estimation. However, here range-Doppler embeddings are learned which correspond to video embeddings and angular spectrogram embeddings that encode the objects of interest present in the video (and their spatial and kinematic properties). It is to be understood that the use of such permuted radar representations is obvious to a person skilled in the art.

In yet another embodiment, the two radar data representations to be jointly embedded with video may be disaggregated into three radar primitives: range spectrograms, Doppler spectrograms, and angle spectrograms. The principles disclosed above may also be generalised to a four-branch network for jointly embedding the disaggregated radar data with video. In such an embodiment, each branch encodes only a 1D radar primitive (range, Doppler, or angle) measured across time to give a 2D input spectrogram. Similar procedure to the one disclosed above applies for constructing positive samples and implementing a four-way contrastive learning. It is to be understood that the use of such disaggregated radar representations is obvious to a person skilled in the art.

Another embodiment of concepts disclosed may relate to using another visual modality in place of RGB images such as lidar for instance. In this case, similar learning architecture may be used with slight alternations to the vision branch in order to accommodate the point cloud nature of lidar. Learning would remain driven by multimodal mutual information (i.e., commonalities between radar and another visual modality arising from observing the same underlying physical environment) regardless of the exact nature of the optical signal used alongside radar data. It is to be understood that the use of a different optical modality is obvious to a person skilled in the art.

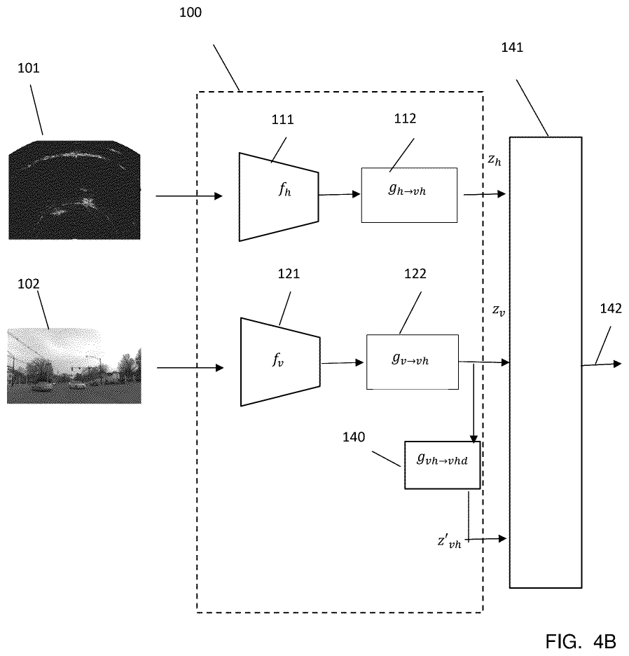

Once the joint embedding neural network is trained (i.e., base neural network), another “task-specific” neural network can be constructed as depicted in FIG. 4. Specifically, the task-specific network may be generated by stacking task-specific neural network layers on top of at least part of the base neural network which has been pretrained separately on unlabelled paired camera-radar data.

A first possibility is shown in FIG. 4A in which the task-specific neural network comprises the encoders ƒₕ, ƒᵥ and ƒ_{d} of the trained base network 100 of FIG. 1, though not the projection heads of FIG. 1 (which may be discarded), and one or more additional layers 141 configured to generate an output 142. The additional layers 141 receive the outputs of all three of the encoders, though in a variation they might just receive any subset of them including the output of the encoder ƒₕ. Note that the task-specific neural network 141 of FIG. 1 uses all three of a radar dataset 101, visual dataset 102 and a Doppler data set 109, which may optionally be derived from the radar dataset 101 by the methods explained above. Note that the task-specific neural network may be able to perform the task adequately even if (e.g. due to adverse weather conditions) the visual data set 102 is corrupted. In a variant of the task-specific network of FIG. 4A, the visual network 121 and/or Doppler network 131 may be omitted, so that the additional layers 141 only receive the output of the radar network 111 upon processing a radar dataset 101. In other words, though visual data and/or Doppler data may be used during the training of the radar network 111, thereby making it possible to use unlabeled training data elements to train the radar network, even though visual data and//or Doppler data may be not be used in the task-specific network which incorporates the radar network 111.

A second possibility is shown in FIG. 4B. The task network includes the encoders ƒₕ and ƒᵥ of FIG. 1, and the projection heads g_{h→vh}, g_{v→vh}, and g_{vh→vhd}. Here, the radar data is not used to produce Doppler data. Instead, the Doppler data is estimated from the projection vector zᵥ obtained from visual data set 102 using the projection set 140.

In all of these cases, the overall task-specific network is then trained (or fine-tuned) on task-specific labelled data (i.e. a second database of radar data set training elements and corresponding labels indicative of the result of performing the task on the corresponding radar data set training element) in order to support task-specific inferences. This may be done in a supervised learning procedure by iteratively updating the numerical parameters of the additional layer(s) 141, optionally while leaving the parameters of the base neural network 100 unchanged. Chen T, Kornblith S, Norouzi M, Hinton G E, Swersky K J, inventors; Google LLC, assignee. Systems and methods for contrastive learning of visual representations. United States patent U.S. Pat. No. 11,386,302, dated 2022 Jul. 12, which is incorporated herein by reference in its entirety, treated a general notion of contrastive pretraining of a base neural using the second training database. Using these techniques, variable numerical parameters defining the operation of the additional layers 141 are trained using the second database.

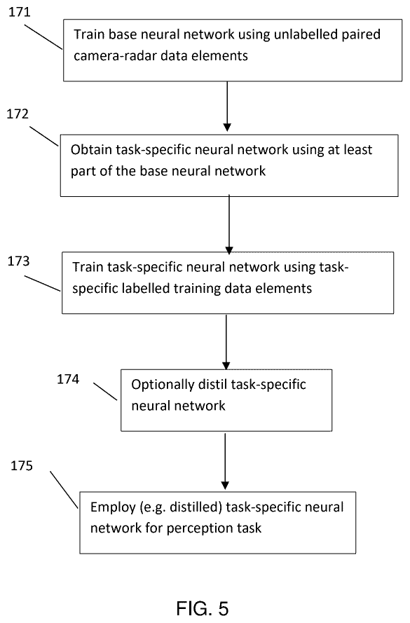

FIG. 5 summarises the overall method 170 for constructing and using a task-specific neural network using the disclosed self-supervised multi-representation learning method. Similar to Chen et al. (2022), this procedure comprises: base contrastive training (or pretraining), generating a task-specific network in part using the base pretrained network, fine-tuning the task-specific network, and optionally distilling the task-specific network into a smaller variant for efficiency.

In step 171, unlabeled paired camera-radar data, which can be obtained cheaply, is used to train a base neural network by the method explained above with reference to FIG. 2. Each iteration may include updating the respective sets of numerical parameters defining at least one of the radar network, visual network or Doppler network. Even if the numerical parameters for all three of these networks are not updated in every iterations, the numerical parameters for all three of the networks are updated in at least some of the iterations, such that all three of the networks are jointly trained. The training may be performed iteratively until a first termination criterion is reached (e.g. that a certain number of training iterations has been performed, or that a certain amount of computing resources has been consumed).

In step 172 a task-specific neural network is formed using at least part of the trained base neural network. The task-specific neural network may comprise one or more (or all) layers of the trained base model, and optionally one or more additional layers. These may be configured to receive the output of the (at least part of) the trained base model.

In step 173, the task-specific neural network is trained, as explained above, by supervised learning using a second training database of training data elements. These may be task-specific labelled data, each comprising a data element for input to the task-specific neural (e.g. a radar data set) and a corresponding desired network output for the task-specific neural network. In step 173, an iterative procedure is performed in which, in each iteration, numerical parameters defining the task-specific neural network, e.g. numerical parameters defining the additional layers, are varied to make a corresponding output of the task specific neural network upon processing at least one of the training data elements closer to the corresponding desired network output. The training may be performed iteratively until a second termination criterion is reached (e.g. that a certain number of training iterations has been performed, or that a certain amount of computing resources has been consumed). While it is true that labelled training data elements are used in this step, since they are only used for fine tuning (e.g. to train the additional layers (e.g. additional layers 141), the number of training data elements required is much smaller than to train the entire task-specific neural network from scratch.

In step 174, an optional distillation step is performed, e.g. by a known method, to “distil” the trained task-specific neural network (e.g. to reduce the number of its numerical parameters).

In step 175, the trained (and optionally distilled) task-specific neural network is deployed to perform a perception take in relation to a real-life environment. The trained task-specific neural network is configured to receive a data element comprising at least a radar data set (and optionally also visual data set), and process it to generate a network output which is the result of performing the perception task on the data element. For example, step 175 may be carried out by a processor on a vehicle (not necessarily the same computer system which performed steps 171 to 174), based on radar data (and optionally visual data and/or Doppler data derived from the radar data) captured by radar sensors (and optionally camera(s)) located on the vehicle), as part of a control system for controlling the vehicle. The control system generates command data which may be implemented by the vehicle to direct the vehicle and control its speed. The task-specific neural network may supplement or replace a conventional vehicle control system. For example, the task-specific neural network may only be employed when it has been determined that a criterion is met indicating that controlling the car based only on visual data captured by the camera(s) is not reliable (e.g. a criterion indicating adverse weather conditions).

The description and drawings merely illustrate the principles of exemplary embodiments. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of exemplary embodiments and the concepts contributed by the inventor(s) to furthering the art, and are to be construed as being without limitation to such specifically recited examples and conditions. Moreover, all statements herein reciting principles, aspects, and embodiments, as well as specific examples thereof, are intended to encompass equivalents thereof.

It should be appreciated by those skilled in the art that any block diagrams herein represent conceptual views of illustrative software code or circuitry embodying exemplary embodiments. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

A person of skill in the art would readily recognise that steps of various above-described methods can be performed and/or controlled by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as magnetic disks and magnetic tapes, hard drives, or optically readable digital data storage media. The embodiments are also intended to cover computers programmed to perform said steps of the above-described methods.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

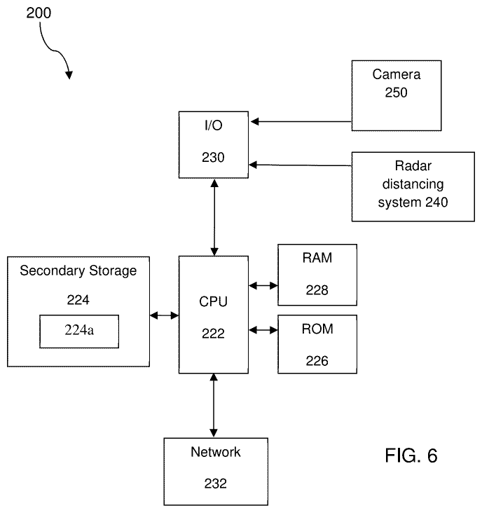

FIG. 6 is a block diagram showing a technical architecture of a server 200 which may be employed to perform the method of FIG. 5.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232. The IO devices 230 provide an interface to a video camera 250 and to a radar distancing system 240. The video camera 250 and radar distancing system 240 (radar sensor) may be configured to capture respective data substantially simultaneously from a real-world environment. The video camera 250 and the radar distancing system 240 have equal (or at least overlapping) fields of view, so both capture data of the same scene evolving in time.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has an order processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

What is claimed is:

1. A method of training a base neural network to process a radar data set to generate an encoding of the radar data set, the method employing:
a plurality of data elements, each data element comprising a corresponding radar data set, a corresponding Doppler data set and a corresponding visual data set, the corresponding radar data set, corresponding Doppler data set and corresponding visual data set being descriptive of a corresponding scene;
the base neural network comprising:
a radar network for processing a radar data set and defined by a plurality of radar numerical parameters;
a Doppler network for processing a Doppler data set and defined by a plurality of Doppler numerical parameters; and
a visual network for processing a visual data set and defined by a plurality of visual numerical parameters;
the method comprising multiple iterations, each iteration employing a corresponding one of the data elements, and comprising:
(i) updating at least one of the radar numerical parameters and the visual numerical parameters to increase a first similarity score measuring a similarity between an output of the radar network upon processing the corresponding radar data set and an output of the visual network upon processing the corresponding visual data set; and/or
(ii) updating at least one of the visual numerical parameters and the Doppler parameters to increase a first similarity score measuring a similarity between the output of the visual network upon processing the corresponding visual data set and an output of the Doppler encoding network upon processing the corresponding Doppler data set.

2. The method of claim 1 in which the radar network is configured, upon processing a radar data set, to generate an output as a first one dimensional vector,
the visual network is configured, upon processing a visual data set, to generate an output as a second one dimensional vector; and
the Doppler network is configured, upon processing a Doppler data set, to generate an output as a third one dimensional vector.

3. The method of claim 1 in which, for each data element, the corresponding radar data set and corresponding visual data set describe the evolution of the scene during a period of time.

4. The method of claim 3 in which each visual data set is a video element comprising a sequence of two-dimensional images.

5. The method of claim 3 in which each radar data set is a range-angle heatmap sequence.

6. The method of claim 3 in which each radar data set comprises a range spectrogram, a Doppler spectrogram and an angle spectrogram.

7. The method of claim 1 further comprising generating, for each data element, the corresponding Doppler data set and the corresponding radar data set from captured corresponding captured radar data.

8. The method of claim 1 in which, for each data element, the corresponding Doppler data set is a plurality of spectrograms representing respective objects in the scene, the second similarity score being calculated using respective outputs of the Doppler network for each of the spectrograms.

9. The method of claim 8 in which the second similarity score is calculated using a multi-positive contrastive loss function.

10. The method of claim 1 in which at least one of the first similarity score and the second similarity score is calculated as a bidirectional contrastive loss.

11. The method of claim 1 in which the second similarity score is calculated based on a projection of the output of the visual network by a projection network, the method further comprising training the projection network.

12. The method of claim 1 in which in each iteration only one of the plurality of radar parameters, the plurality of visual parameters and the plurality of Doppler parameters is trained.

13. A method of forming a task-specific network for processing a radar data set to generate a task output, the method comprising:
training a base neural network comprising:
a radar network for processing a radar data set and defined by a plurality of radar numerical parameters;
a Doppler network for processing a Doppler data set and defined by a plurality of Doppler numerical parameters; and
a visual network for processing a visual data set and defined by a plurality of visual numerical parameters;
the method further comprising:
using at least part of the trained base neural network to form a task-specific network, and
training the task-specific network using radar data set training elements and corresponding labels indicative of the result of performing the task on the corresponding radar data set training element.

14. The method of claim 13 in which the training of the base neural network is performed by contrastive learning, to minimize a measure of similarity between corresponding outputs of the radar network, Doppler network and visual network upon respectively receiving a corresponding radar data set, a corresponding Doppler data set and a corresponding visual data set, the corresponding radar data set, corresponding Doppler data set and corresponding visual data set being descriptive of a corresponding scene.

15. The method of claim 13 further comprising reducing the number of numerical parameters in the trained task-specific neural network to form a distilled task-specific neural network.

16. A method of performing a task on a radar data set, the method employing a task-specific network obtained by:
training a base neural network comprising:
a radar network for processing a radar data set and defined by a plurality of radar numerical parameters;
a Doppler network for processing a Doppler data set and defined by a plurality of Doppler numerical parameters; and
a visual network for processing a visual data set and defined by a plurality of visual numerical parameters;
using at least part of the trained base neural network to form a task-specific network, and
training the task-specific network using radar data set training elements and corresponding labels indicative of the result of performing the task on the corresponding radar data set training elements;
the method comprising using the trained task-specific network to process a received radar dataset to generate corresponding labels.
